(19) United States
(12) Patent Application Publication
(10) Pub. No.: US 2004/0181859 A1
(43) Pub. Date: Sep. 23, 2004

(54) Protective clothing

(76) Inventor: Rolf Lehmann, Hamburg (DE)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/768,221

(22) Filed: Jan. 29, 2004

(30) Foreign Application Priority Data
Jan. 31, 2003 (DE) 203 01 580.0
Aug. 14, 2003 (DE) 203 12 739.0
Dec. 5, 2003 (DE) 203 19 008.04

(51) Int. Cl. A62B 17/00; A41D 1/00; G21F 3/02; F41H 1/00

(52) U.S. Cl. 2/455

(57) ABSTRACT

A protective textile material consisting of several material layers is proposed to provide protective clothing that simultaneously satisfies varying requirements, wherein at least one material layer is a flame-resistant and/or flame-retardant material (10, 30), and at least one other material layer is a cut-resistant protective material (11, 31) and/or a bullet or bayonet-proof material. Corresponding cut-resistant protective pants (20) with leg sleeves (22) forming two pant legs, wherein each leg sleeve (22) can be opened at least in part by at least one locking means (26, 27), are characterized in that the leg sleeves (22) are joined with an upper section (21), in particular for protecting the chest area of an individual, so that safety pinafore overalls are created, and the pinafore overalls (20) consist of a protective textile material.

The invention relates to a protective textile material consisting of several material layers, an article of clothing as a cut-resistant article of clothing, such as cut-resistant leg sleeves, pants, boiler suit, jacket, vest, pinafore overalls or protective suit, and in particular cut-resistant protective pants.

Articles of clothing that protect individuals using motor saws against cuts are known in the art. The design of such cut-resistant protective clothing has been described, for example, in European Standard EN 381-4:1995. The protective clothing is comprised of fabric, knitwear or thread composites made of synthetic, in part high-strength fibers.

A special protective effect is achieved by having the serrated teeth snag one or more fibers and tear them out of the composite. These torn-out fiber bundles block the bearings or chain guides until the tool ceases to operate (DE 100 36 488 A1).

The upper material of this protective clothing generally consists of a mixture of cotton and synthetic fibers, which facilitates wearing comfort.

Protective clothing is also worn in another area, specifically relating to individuals involved in rescue or firefighting operations. The design of this type of protective clothing is described, for example, in European Standards EN 469 and EN 531. As a rule, protective clothing for rescue operations has the following features:

incombustible,

afterburn/afterglow time under 2 seconds,

does not melt,

does not drip,

does not ignite,

very high heat transfer resistance,

long-lasting water and oil-repelling properties,

highly visible through the use of a combination of reflective and persistent materials.

Protective clothing for firefighters designed to provide thermal insulation is known, for example, from DE 694 17 757 T2.

Flame-retardant yarns and fabrics manufactured from them are known from DE 100 38 030.

In rescue operations requiring the use of handheld power tools, e.g., motor saws, rescue workers use the currently available cut-resistant protective clothing described above. In this case, rescue workers must do without features of protective clothing for rescue operations. In particular the lack of protection against fire and melting makes it impossible to use the cut-resistant protective clothing in all necessary operations.

Another problem with respect to protective clothes, in particular cut-resistant protective pants, is that they are cumbersome and time-consuming to put on. The cut-resistant protective pants known from prior art have leg sleeves that form two pant legs that can be opened from top to bottom by means of a zipper running along the inner thigh. The pant legs are joined via a wide suspender belt, which can also be opened by means of a zipper. Such pant legs have proven difficult to use, and the wearer lacks protection primarily in the chest area. This area is not protected by suitable means against injury, e.g., caused by motor saws. Cut-resistant protective pants are known from GB 2,226,943A. In addition, putting on the cut-resistant leg sleeves is cumbersome and time-consuming. Donning the pant legs is additionally hampered when wearing heavy protective clothing, e.g., a firefighting gear. The clumping, large boots of such protective gear make it impossible to slip cut-resistant protective pants over the pant models. As a consequence, cut-resistant protective clothing is either not put on, or involves time delay to don. And this delay must be avoided, e.g., during use by firefighters.

Therefore, the object of the invention is to provide protective clothing that simultaneously satisfies the different requirements.

A protective textile material with the features in claim 1, an article of clothing with the features in claim 4, as well as cut-resistant protective pants with the features in claim 6 are proposed for achieving this object.

In the solution according to the invention, a material layer of the kind required for making cut-resistant protective clothing is here combined with a material layer of the kind required to achieve protection against fire and melting, thereby yielding cut-resistant protective clothing that combines the advantages of known cut-resistant protective clothing with protective clothing for rescue personnel.

This combination makes it possible to manufacture clothing that satisfies the requirements placed on the functionality of protective clothing worn by rescue personnel, i.e., that embodies the features of protective clothing for rescuer personnel cited above, and in particular satisfies the corresponding standards, both for cut-resistant protective clothing and protective clothing worn by rescue personnel.

It is advantageously provided that the material serving as the flame-resistant and/or flame-retardant material be designed to protect against fire and melting.

In the material serving as the cut-resistant protective material, it is provided that a layer comprised of lining thread and loops that blocks the tool in case of contact be arranged via a textile back cloth on the machine side from the tool to protect against injury caused by power tools, e.g., chainsaw or circular saw.

The article of clothing can advantageously be designed as a cut-resistant protective pant leg, pant, boiler suit, jacket, vest, pinafore overalls or protective suit.

The object described above is also achieved with cut-resistant protective pants with the features denoted in claim 6, advantageous further developments of which are described in claims 7 to 16.

According to the invention, the cut-resistant protective pants having leg sleeves that form two pant legs is connected with an upper section used for protecting the chest area of an individual. The pant legs can advantageously here be opened at least partially by means of at least one connection means. A cut-resistant protective material layer and a protective layer against fire and melting preferably covers the entire pinafore overalls, i.e., even the area of the upper section, thereby yielding an effective protection, in particular for the chest area and legs of the user, which is not possible with the pants known from prior art.

In another further development of the invention, the pinafore overalls are made completely of cut-resistant protective material. Depending on what the pinafore overalls are used for, however, they can also consist of several layers of material, at least one material layer can be a flame-resistant and/or flame-retardant material, and at least one additional material layer can be a cut-resistant protective material and/or a bullet or bayonet proof material.

In a preferred embodiment of the invention, the leg sleeve has a lower area with an entry hole provided with a ring.

The ring can consist of a plastic or metal, for example. As opposed to the known leg sleeves, the pant legs according to the invention cannot be completely opened any more by a connection means. The connection means, which is preferably a zipper, extends from an area of the leg sleeve facing the upper section up to the ring, so that the leg sleeve can open only along this area. In another alternative, a Velcro fastener is also possible as the connection means.

An expanse proceeding from the entry hole toward the upper section remains unable to open in the lower area of the leg sleeve. In this case, the ring is preferably secured to the inside of the leg sleeve, so that it cannot be seen from outside. Attachment can take place by sewing the ring to the leg sleeve, for example. Other connection means are also conceivable. The significant advantage to designing the leg sleeves in this way is that the user can easily put on the pinafore overalls. While putting them on, the connection means, in particular the zipper, is open, forming two leg flaps. The user puts his legs laterally into the leg flaps through the entry holes. Since the ring reliably holds the entry hole open, the pinafore overalls according to he invention can be slipped over comfortably without taking a lot of time, even with clumpy or large boots. A web can be built into the lower area of the web sleeve according to the invention instead of a ring. This approx. 10 cm wide, continuous web forms an entry hole for the respective left and right leg. The hole is cut wide enough to easily enable entry, even with clump and heavy boots.

In another alternative to the invention, the ring or web is spaced apart from the entry hole of the leg sleeve. This means that the lower area of the ring or web facing away from the upper section is not flush with the entry hole. The pinafore overalls are here also made easier to put on by comparison to the pants known from prior art.

It can also be advantageously provided that a neck belt having adjustment means is arranged in an area of the upper section facing away from the leg sleeve. The user drapes the neck belt over the neck, wherein the belt length can be set or varied using the adjustment means. A locking means is preferably included in the belt, making it possible to close and open the belt. The locking means can be a Velcro fastener, for example.

The area of the leg sleeve facing the upper section best has a Velcro fastener. Once the legs or feet of the user have passed through the entry holes, the leg flaps can be fixed in place using the Velcro fastener located on the side of the leg sleeve before the locking means running longitudinally along the leg sleeve is closed.

In another variant of the invention, the upper section has a lap belt system with two belt ends that can be joined by a locking means. The belt system preferably consists of two belts secured to the upper section on the sides opposite the belt ends. To ensure that the pinafore overalls according to the invention fit snugly against the body of the user, the belts are passed around the body, and the belt ends are then connected via the locking means. A latching system or Velcro fastener can be used as the locking means, for example. The belt system can also provide an adjustment means with which the length of the belt can be adjusted. In one possible embodiment, the adjustment means is integrated into the locking means.

The drawing shows exemplary embodiments of the invention. Shown on:

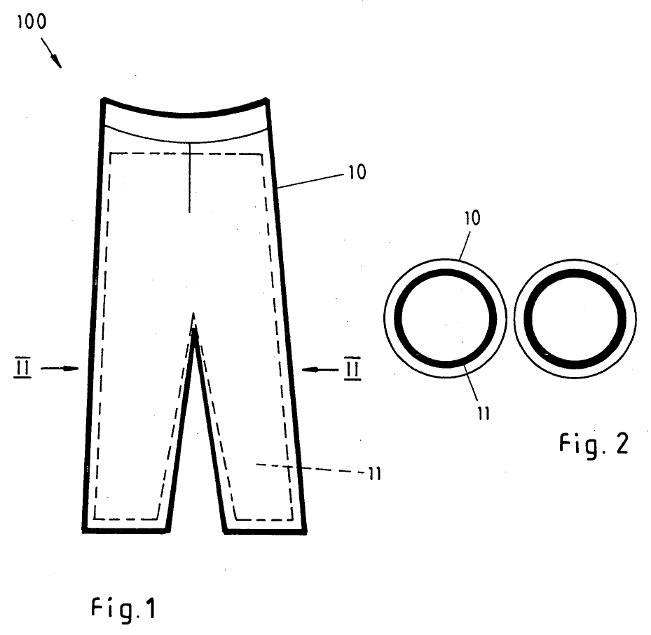

FIG. 1 is a diagrammatic top view of cut-resistant protective pants with implied material structure;

FIG. 2 is a diagrammatic view of a cross-section II-II through the cut-resistant protective pants according to FIG. 1;

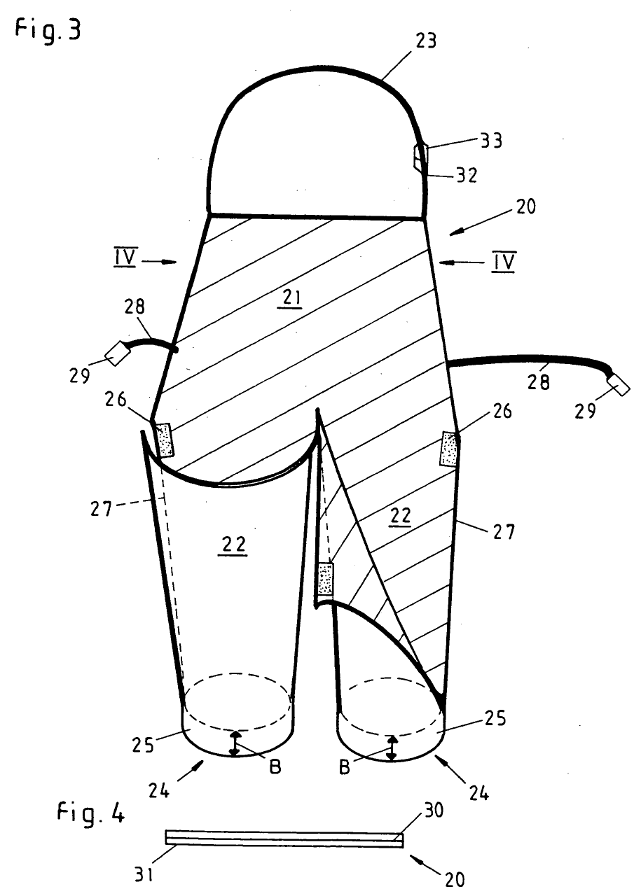

FIG. 3 is a diagrammatic view of pinafore overalls, and

FIG. 4 is a diagrammatic view of a cross-section IV-IV through the pinafore overalls according to FIG. 3.

The outer section of the cut-resistant protective pants 100 shown in purely diagrammatic form on FIGS. 1 and 2 has the comfortable styling usual for such work clothes. Basically no limits are placed on the cut, zipper, pocket, sleeve pocket and cuff design. However, they are respectively specified in the pertinent standards and regulations. The cut-resistant protective pants are here designed in such a way that the outer fabric 10 consists of a fireproof material according to EN 469/531, e.g., “Nomex III”. One example is “Nomex III” from DuPont. A cut-resistant insert according to EN 381 is provided on the inside as a cut-resistant protective material 11, as shown on FIG. 2.

Only the basic structural design is here involved, of course. The article of clothing can be fabricated out of multi-layer material, wherein a flame-resistant outer fireproof material 10, a moisture barrier (not shown in the drawing) and thermally insulating lining (also not shown) can be sequentially provided, then followed by the cut-resistant insert comprised of a cut-resistant protective material 11, in which a layer consisting of lining threads and loops that blocks the tool in the event of contact is arranged over a base textile material on the machine side, i.e., directed toward the outer fireproofing fabric, to protect against injuries caused by power tools or power equipment such as chainsaws or circular saws. An inner lining (also not shown) can then be provided on the inside to enhance wearing comfort.

To expand the applicability of such an article of clothing, the cut-resistant insert can be replaced by a bullet and bayonet proof insert, so that this clothing can also be used in military or police rescue operations in crisis areas.

FIG. 3 shows another exemplary embodiment of pinafore overalls 20 with leg sleeves 22 forming two pant legs. As in the case of the cut-resistant protective pants 100 according to FIGS. 1 and 2, the pinafore overalls 20 consist of several material layers 30, 31, as illustrated in particular on FIG. 4. In this example, the structural design of the pinafore overalls 20 is selected in such a way that an outer layer 30 is comprised of a fireproof material, and another layer 31 designed as the cut-resistant protective material is provided.

The pinafore overalls 20 additionally have an upper section 21 lying above the leg sleeves 22, which is connected in a single piece with the leg sleeves 22, wherein the upper section 21 is shaped like a trapezoid in this exemplary embodiment. When worn, the overalls 21 are used to protect the chest area of an individual. In addition, a neck belt 23 is situated in an upper area of the upper section 21 facing away from the leg sleeves 22, which the user can hang around his neck, so that the pinafore overalls 20 can be reliably positioned in front of the body of the user. The neck belt 23 has an adjustment means 32 with which the user can adjust the length of the neck belt 23 as desired. Further, the neck belt 23 can be opened using a locking means 33 consisting of a latching element and counter-latching element.

A lap belt system consisting of two belts 28 is arranged in roughly the middle of the upper section 21. The belts 28 are each sewn to the opposing lateral areas of the upper section 21, and each have a free end provided with a locking means 29. In order to effectively fix the pinafore overalls 20 snugly against the body of the user, the free ends are passed around the body of the user and joined, wherein the locking means 29 are brought into contact with each other. In the example shown, the locking means 29 is a Velcro fastener. However, other locking means are also conceivable, of course.

The leg sleeves 22 forming the pant legs each have a large-diameter entry hole 24 situated on the side facing away from the upper section 21. This ensures easy entry even with large work shoes.

Arranged on the side of each leg sleeve 22 is a connection means 27 that runs from an upper area of the leg sleeve 22 toward the entry hole 24. The connection means 27, a zipper in this example, makes it possible to open the pant leg on the side. Also situated in the lower area of the leg sleeve 22 provided with the entry hole 24 is a ring 25 made of metal. The ring 25 is here approx. 10 cm in width B, and is sewn into the material of the leg sleeve 22. In another embodiment (not shown, the ring 25 can also be attached to the leg sleeve 22 in another manner. In this embodiment, the laterally running zipper 27 extends from the upper area of the leg sleeve 22 facing the upper section 21 up to the ring 25, so that the leg sleeve 22 can only be partially opened, i.e., from the upper area of the leg sleeve 22 to the ring 25. Also arranged at the upper area of the leg sleeve 22 adjacent to the zipper 27 is another connection means in the form of a Velcro fastener.

The pinafore overalls 20 are donned in such a way that the user initially hangs the neck belt 23 over the neck, so that the pinafore overalls 20 are located in front of the body. Based on the corresponding requirements of the user, e.g., body size, etc., the length of the neck belt 23 can be altered accordingly. The user then puts his left and right legs into the open leg sleeves 22, which form two leg flaps, through entry holes 24. The large diameter of the entry holes 24 along with the rings 25 situated in the lower area of the leg sleeves 22 here make it easier for the user to put on the pinafore overalls 20. Once both legs or feet have been passed through the entry holes 24, the leg flaps are fixed in place by the Velcro fasteners 26 before the zippers 27 on the side are pulled from the bottom up, thereby forming two closed pant legs. The user closes the two belts 28 of the lap belt system to ensure a snug fit of the pinafore overalls 20.

The new pinafore overalls are very easy to use:

An adjustable neck strap with fastener is secured to the upper section of the pinafore overalls, and an adjustable lap belt with fastener is located in the lap area. In order to put on the pinafore overalls, the user hangs the strap over his neck, so that the pinafore overalls are suspended in front of him on the body. He now puts his left and right legs into the leg holes, joins the leg flaps in the hip area with Velcro fasteners, and pulls zippers on both outer sides from the bottom up, thereby forming a leg tube on each side. The user closes an adjustable coupling/lap belt to ensure a snug fit of the pinafore overalls. The composition of the outer and inner material depends on the application. Conventional and typical materials are selected for cut-resistant protective clothing used in forestry operations, while fireproof outer and inner materials are selected for rescue operations.

The invention is not limited to the exemplary embodiments shown in the drawings. The same basic structural design is conceivable for cut-resistant leg sleeves, pants, boiler suits, jackets, vests or protective suits. In principle, each corresponding article of clothing can be made out of such a protective textile material to achieve the advantageous effects.

Reference List

| | |
|---|---|
| 10, 30 | Fireproof material |
| 11, 31 | Cut-resistant protective material |
| 20 | Pants |
| 21 | Upper section |
| 22 | Leg sleeve |
| 23 | Neck belt |
| 24 | Entry hole |
| 25 | Ring |
| 26, 27 | Connection means |
| 28 | Belt |
| 29 | Locking means |
| 32 | Adjustment means |
| 33 | Locking means |

1. A protective textile material consisting of several material layers, characterized in that at least one material layer is a flame-resistant and/or flame-retardant material (10, 30), and at least another material layer is a cut-resistant protective material (11, 31), and/or a bullet or bayonet proof material.

2. The protective textile material according to claim 1, characterized in that the flame-resistant and/or flame-retardant material (10, 30) is designed to protect against fire and melting.

3. The protective textile material according to claim 1 or 2, characterized in that the cut-resistant protective material (11, 31) is arranged as a layer comprised of lining thread and loops that blocks the tool in case of contact in a known manner via a textile back cloth on the machine side from the tool to protect against injury caused by power tools, e.g., chainsaws or circular saws.

4. An article of clothing as a cut-resistant article of clothing, such as cut-resistant leg sleeves, pants, boiler suit, jacket, vest, pinafore overalls or protective suit, and in particular cut-resistant protective pants.

5. An use of a protective textile material according to one of claims 1 to 3 to form an article of protective clothing.

6. A cut-resistant protective pants (20) with leg sleeves (22) forming two pant legs, wherein each leg sleeve (22) can be at least partially opened using at least one connection means (26, 27), characterized in that the leg sleeves (22) are connected with an upper section (21), in particular for protecting the chest area of a person, thereby resulting in safety pinafore overalls.

7. The cut-resistant protective pants according to claim 6, characterized in that the lower area of the leg sleeve (22) is provided with an entry hole (24) having a ring (25) or a web.

8. The cut-resistant protective pants according to claim 6 or 7, characterized in that the ring (25) or web is made out of plastic or metal.

9. The cut-resistant protective pants according to one of the preceding claims, characterized in that the ring (25) or web is spaced apart relative to the entry hole (24) of the leg sleeve (22).

10. The cut-resistant protective pants according to one of the preceding claims, characterized in that the pinafore overalls (20) has at least one layer (31) consisting of cut-resistant protective material.

11. The cut-resistant protective pants according to one of claims 6 to 9, characterized in that the pinafore overalls (20) consists of a protective textile material according to one of claims 1 to 3.

12. The cut-resistant protective pants according to one of the preceding claims, characterized in that an area of the upper section (21) facing away from the leg sleeve (22) has a neck belt (23) equipped with an adjustment means (32) and/or a locking means (33).

13. The cut-resistant protective pants according to one of the preceding claims, characterized in that the upper section (21) has a lap belt system (28) with two free belt ends that can be joined by a locking means (29).

14. The cut-resistant protective pants according to one of the preceding claims, characterized in that the leg sleeve (22) can be opened from an area facing the upper section (21) up to the ring (25) or web.

15. The cut-resistant protective pants according to one of the preceding claims, characterized in that the connection means (26, 27) is a zipper (27) and/or a Velcro fastener (26).

16. The cut-resistant protective pants according to one of the preceding claims, characterized in that the Velcro fastener (26) is arranged on the area of the leg sleeve (22) facing the upper section (21).
